(19) United States
(12) Patent Application Publication
(10) Pub. No.: US 2012/0004374 A1
(43) Pub. Date: Jan. 5, 2012

(54) METHOD FOR THE CONTINUOUS PRODUCTION OF SILANE TERMINATED PRE-POLYMERS

(75) Inventors: Volker Stanjek, Ampfing (DE); Wolfgang Wewers, Burghausen (DE)

(73) Assignee: Wacker Chemie AG, Munich (DE)

(21) Appl. No.: 13/255,183

(22) PCT Filed: Mar. 1, 2010
(86) PCT No.: PCT/EP10/52522

§ 371 Date: Sep. 7, 2011

(30) Foreign Application Priority Data
Mar. 11, 2009 (DE) 10 2009 001 489.6

(51) Int. Cl. C08G 18/12

(52) U.S. Cl. 525/460

(57) ABSTRACT

The invention relates to the continuous production of prepolymers (A) having end groups of the general formula (1): (R¹)ₐ(R²)₃₋ₐSi—X-A, wherein the end groups (1) can be identical or different, A is a two-band link group selected from —(R³)N—CO—NH—, —HN—CO—N(R³)—, —O—CO—HN—, —HN—CO—O—, S—CO—HN—, —HN—CO—S—, X is a two-band, linear or branched alkyl group, optionally substituted with halogen atoms, having 1-10 carbon atoms, R¹ is an alkyl, cycloalkyl, alkenyl or aryl residue, optionally substituted with halogen, having 1-10 carbon atoms, R² is an alkoxy residue —OR³, an acetoxy residue —O—CO—R³, an oxime radical —O—N═C(R³)₂ or an amine residue —NHR³ or —NR³₂R³ is hydrogen, a linear, cyclical or branched radical, substituted with heteroatoms, having 1 to 18 carbon atoms, R⁴ is a linear, branched or cross-linked polymer radical, a is 0, 1 or 2, and n is a whole number that is at least 1, wherein the prepolymers (A) are produced by a continuous method comprising at least one reaction of an isocyanate group (—N═C═O) having at least one isocyanate reactive group, that is carried out continuously in at least one reactor (R), that enables heat dissipation capacities of greater than 5 kW/(m³·K) in the laminar flow region.

### CROSS REFERENCE TO RELATED APPLICATIONS

This application is the national phase filing of international patent application No. PCT/EP2010/052522, filed 1 Mar. 2010, and claims priority of German patent application number 10 2009 001 489.6, filed 11 Mar. 2009, the entireties of which applications are incorporated herein by reference.

### FIELD OF THE INVENTION

The invention relates to a method for continuous production of moisture-crosslinking silane-terminated prepolymers based on short-chain polyols, di- or polyisocyanates and also alkoxysilanes with isocyanate groups and/or isocyanate-reactive groups and to their use, particularly in moisture-curing assembly foams.

### BACKGROUND OF THE INVENTION

Silane-terminated polymers are important binders for diverse adhesive and sealant materials and are extensively described in the literature. In one group of silane-terminated polymers, which is one of the most important ones because it is the most diverse in terms of chemical construction and the property profile resulting therefrom, the silane termini are attached to the polymer backbone via urethane and/or urea units. These polymers are typically produced by reacting very long-chain polyols (polyether polyols, polyester polyols or OH-functional polyurethanes having molar masses which are typically distinctly above 5000 g/mol and mostly even above 10 000 g/mol) with an alkoxysilyl-functional isocyanatoalkylsilane.

These polymers can also be produced continuously as described inter alia in WO 2006/136261 A1, in which case both the reactants are initially mixed together with each other in a mixing unit and then reacted with each other in a reactor. The reactor is typically a heatable tube wherethrough the reaction mixture react with each other at a predetermined temperature with or without continued commixing.

A further way to produce silane-functional polymers is to react polyols (e.g., polyether polyols, polyester polyols) with a di- or polyisocyanate in a reaction wherein the polyol component is used in excess and the excess OH functions are reacted with an alkoxysilyl-functional isocyanatoalkylsilane. It will be appreciated that the order of the reaction steps is interchangeable in principle. It is also conceivable to carry out the two reaction steps concurrently.

A third way to produce silane-functional polymers is to react polyols (e.g., polyether polyols, polyester polyols) with a di- or polyisocyanate in a reaction wherein the polyol component is used in deficiency and the excess NCO groups are reacted with an alkoxysilyl-functional silane having at least one NCO-reactive group (e.g., silanes with primary and/or secondary amino group). It will be appreciated that the order of the reaction steps is interchangeable in principle. It is also conceivable to carry out the two reaction steps concurrently.

The two last-mentioned silane-functional types of prepolymer can in principle also be produced without a solvent in a continuous process, for example in a tubular reactor as described inter alia in WO 2006/136261, provided the polyols used have a relatively high chain length.

However, it is disadvantageous that silane-terminated polymers based on long-chain polyols are not suitable for many uses in which the cured products have to be of high or even very high hardness. This applies particularly to the production of silane-terminated polymers useful as base material for sprayable assembly foams. Although silane-terminated prepolymers based on long-chain polyols, especially on long-chain polyether polyols, are highly elastic owing to the correspondingly resulting long—generally flexibilizing—polyether segments, they are much too soft for use in sprayable assembly foams. Silane-terminated prepolymers which are based on very short-chain polyols and which are of the type suitable for use in sprayable assembly foams are described in WO 02/066532 A for example.

To produce prepolymers that cure to form such hard or even very hard materials, it is accordingly necessary to proceed from polyols of distinctly lower molar mass, such as preferably molar masses ≦1000 and more preferably molar masses <500. Yet the consequence of this is that, in the synthesis of the corresponding prepolymers, the reaction mixture contains a significantly higher density of reactive groups, since these are now no longer “diluted” by the long, non-reactive chains of the polyol backbone. Since the reaction of NCO groups is substantially exothermic, the corresponding reactions generate a very substantial amount of heat. In the case of a substantially adiabatic operation, the warming of the reaction mass can easily be above 150° C. depending on the chain length of the polyol used, in some instances even above 200° C.

In general, however, it is absolutely necessary for the reaction to be conducted within a relatively narrow temperature window. Excessively high reaction temperatures result in an unacceptable formation of by-products, while excessively low temperatures reduce the reaction rate to the point where the reaction ceases entirely. Reaction temperatures suitable for the formation of urethane and/or urea bridges typically range from 50 to 140° C. and are preferably in the range between 70 and 110° C. To ensure product consistency, it is often even necessary to conduct the reaction within a temperature range of just a few degrees. Typically, the warming of the reaction material should preferably be below 10° C.

To operate the reaction within such a narrow temperature window, it is thus absolutely necessary to remove enormous amounts of energy per kilogram of reaction mass within a very short time (the reactions in question usually go to more than 80% completion within a few minutes).

This is not possible with the continuous process described in WO 2006/136261 A1. This holds particularly because each segment of the tubular reactor described in WO 2006/136261 A1, with upstream mixing unit, would then have to be cooled at a different power rate, since the reaction rate—and hence also the heat evolved—rapidly decreases with increasing reaction time and hence with increasing distance from the mixing unit. At the downstream end of the reactor, even slight heating would presumably be necessary in order that the reaction mass may be maintained at the desired temperature. The exact cooling and heating powers involved are highly dependent on the materials used, but especially also on the residence time and hence on the throughput. Therefore, every product change, every change in the throughput rate and every even the tiniest disruption in the production process would lead to uncontrollable thermal conditions in the reactor. In practice, such a reaction process would simply not be operable.

The problem was accordingly that of providing a continuous method for production of silane-terminated polymers which avoids the disadvantages described above, and which more particularly is suitable for continuous production of silane-terminated polymers based on short—or even very short—chain polyols. The problem was further that of providing silane-terminated polymers which, on curing, attain a high network density and thus a high hardness and are suitable inter alia for the production of silane-crosslinking assembly foams. The problem is solved by the invention.

### SUMMARY OF THE INVENTION

The invention provides a method for continuous production of prepolymers (A) having end groups of general formula (1)

(R¹)ₐ(R²)₃₋ₐSi—X-A- (1),

where the end groups (1) can be the same or different,
A is a divalent linking group selected from —(R³)N—CO—NH—, —HN—CO—N(R³)—, —O—CO—HN—, —HN—CO—O—, —S—CO—HN—, —HN—CO—S—,
X is a divalent linear or branched alkyl group of 1-10 carbon atoms which is optionally substituted with halogen atoms,
R¹ is an optionally halogen-substituted alkyl, cycloalkyl, alkenyl or aryl radical of 1-10 carbon atoms,
R² is an alkoxy radical —OR³, an acetoxy radical —O—CO—R³, an oxime radical —O—N═C(R³)₂ or an amine radical —NHR³ or —NR³₂,
R³ is hydrogen, a linear, cyclic or branched radical of 1 to 18 carbon atoms which is optionally substituted with heteroatoms, preferably an alkyl or alkenyl radical wherein the carbon chain may optionally be interrupted with oxygen atoms, or an optionally substituted aryl radical of 1 to 18 carbon atoms,
R⁴ is a linear, branched or crosslinked polymer radical,
a is 0, 1 or 2, and
n is an integer of at least 1,
   by producing the polymers (A) by a continuous process comprising at least one reaction of an isocyanate group (—N═C═O) with at least one isocyanate-reactive group conducted continuously in at least one reactor (R) which provides heat removal powers above 5 kW/(m³·K) in the laminar region of flow.

### BRIEF DESCRIPTION OF THE DRAWINGS

FIG. 1 is a flow chart depicting a process design according to the invention, with parallel mixing sector, temperature management and reaction management.

FIG. 2 is a flow chart depicting an alternative continuous process according to the invention.

### DETAILED DESCRIPTION OF THE INVENTION

The method of the invention provides production of silane-terminated prepolymers based on short- or even very short-chain polyols in a continuous process since this process has the following distinct advantages:
consistent product quality, i.e., reduced secondary reactions, brief thermal exposure of starting materials and products, enhanced selectivity of reaction.
high space-time yield, i.e., high output coupled with low reactor holdup. This makes a continuous process superior to the batch process with regard to safety-engineering as well as toxicological aspects.
minimization of waste and thus of production costs due to minimization/elimination of solvents.
mixing of very viscous products is better in continuous mixers.
it is a further advantage of continuous processes that in-line analysis can be used to control the quality of the product obtained during the ongoing manufacturing operation by adaptation of reaction parameters, such as residence time, temperature profiles stoichiometry of feed components, etc. Moreover, these processes are simpler to optimize and hence a more efficient use of raw materials is possible.

The reactor (R) used in the method of the invention shall ensure heat removal rates of at least 5 kW/(m³·K) even at Reynolds numbers below 100. Preference here is given to designs providing a specific heat removal rate of at least 10 kW/(m³·K). The range from 20 to 100 kW/(m³·K) is particularly preferred.

Such heat exchange performances are not achievable with conventional reactors as described in WO 2006/136261 A1 for example. The invention reactors (R) therefore preferably include in the delay time sector internal cooling and delay time elements which are overflowed by the reaction medium convectively. Particular preference is given to tubular reactors having internal cooling and delay time elements in the delay time sector.

The internal cooling elements do not just generate a very large area for heat exchange between the cooling medium and the reaction mixture and hence a high heat exchange rate. The cooling elements in a suitable embodiment can simultaneously also ensure/improve the commixing of the reaction mixture. The simultaneous mixing and heat removal thus provides for a high rate of heat removal coupled with low temperature differences between the cooling medium and the reaction mixture. This in turn is a fundamental prerequisite in order that the continuous reaction may be kept within a narrow temperature window irrespective of the exact throughput.

Preferably, the reactor (R) thus likewise provides narrow temperature control, i.e., a temperature rise during the reaction by less than 10° C. and more preferably less than 5° C. even when the reaction mixtures have viscosities above 5 Pa·s at the reaction temperature.

The method of the invention preferably targets a narrow residence time distribution with Bodenstein numbers greater than 3 and preferably greater than 10.

Suitable reactor technologies for construction of invention reactors (R) having the abovementioned high heat removal rates are known in principle, but have hitherto not been used to produce (pre)polymers for silane-crosslinking systems. Particularly preferred types of reactor are tubular reactors having internal cooling and delay time elements as marketed for example by Sulzer (e.g., SMR reactor).

The method of the invention has the advantage that the preferably high-viscosity polymers (A) of the invention are obtainable by the method of the invention in a quality which is equivalent to that of a batch process. This holds especially for the preferred use of polymers (A) in foamable mixtures (M) for sprayable assembly foams. This is surprising inasmuch as the reaction temperature of the highly exothermic reaction in the batch process described for example in WO 02/066532 A is controlled via the dosing rate of a reactant. This way of exerting control is not applicable to a continuous process.

As mentioned, a decisive improvement over known continuous processes as known from WO 2006/136261 A for example resides in the fact that the reactor (R) of the invention makes it possible to achieve effective cooling even with cooling media whose temperature is only minimally below the reaction temperature in reactor (R).

The reactor concept presented thus constitutes an innovative solution to the abovementioned problem of the continuous process described in WO 2006/136261 A, since the reactor of the invention preferably permits heat removal at a temperature difference of not more than 20° C. between the reaction medium and the cooling medium. Preferably, heat removal in the reactor of the invention takes place at a temperature difference of at most 10° C. between the reaction medium and the cooling medium.

This low difference in temperature prevents large differences in viscosity and hence inhomogeneities in the reaction medium of the kind which are likely in the case of a reaction process as per WO 2006/136261 A.

R¹ is preferably a methyl, ethyl or phenyl radical and more preferably a methyl group.

R² is preferably an ethoxy or methoxy group.

A is preferably a urethane group —O—CO—NH— or —NH—CO—O— or a urea unit —NH—CO—NR³— or —NR³—CO—NH—, where R³ is preferably an alkyl or cycloalkyl radical of 1-10 carbon atoms and more preferably of 1-6 carbon atoms or an aryl radical of 6-10 carbon atoms and more preferably a phenyl radical.

X is preferably a linear divalent propylene radical and more preferably a —CH₂— group.

The prepolymers (A) are preferably produced by reaction (a)
of polymers (P) with isocyanate-reactive groups selected from groups of formulae —N(R³)H, —OH or —SH, preferably polymers (P) with OH groups, with
an isocyanate component (I) selected from mono-, di- and polyisocyanates and mixtures thereof, and
a silane (S₁) which includes an isocyanate-reactive group and conforms to general formula (2)

(R¹)ₐ(R²)₃₋ₐSi—X—B₁ (2),

where B₁ is an isocyanate-reactive group selected from groups of formulae —N(R³)H, —OH or —SH, and R¹, R², X and a are each as defined above,
with the proviso that
(i) polymer (P) is reacted first with isocyanate component (I) and then with silane (S₁), or
(ii) isocyanate component (I) is reacted first with silane (S₁) and then with polymer (P), or
(iii) polymer (P), isocyanate component (P) and silane (S₁) are reacted at the same time.

It is possible in this connection for both the reaction steps—i.e., the reaction of polymer (P), preferably polyol (P), with the isocyanate component (I) and the reaction with the silane component (S₁)—to be carried out in the reactor of the invention. It is similarly possible to carry out just one process step—preferably the reaction of polymer (P) with the isocyanate component (I)—in the reactor of the invention.

The prepolymers (A) can also be produced by reaction (b) of
polymers (P) with isocyanate-reactive groups selected from groups of formulae —N(R³)H, —OH or —SH, preferably polymers (P) with OH groups, with
an isocyanate component (I) selected from mono-, di- and polyisocyanates and mixtures thereof, and
a silane (S₂) which includes an isocyanate group and conforms to general formula (3)

(R¹)ₐ(R²)₃₋ₐSi—X—B₂ (3),

where B₂ is a radical of formula —N═C═O and R¹, R², X and a are each as defined above,
with the proviso that
(i) polymer (P) is reacted first with isocyanate component (I) and then with silane (S₂), or
(ii) polymer (P) is reacted first with silane (S₂) and then with isocyanate component (I), or
(iii) polymer (P), isocyanate component (P) and silane (S₁) are reacted at the same time.

It is possible in this connection for both the reaction steps—i.e., the reaction of polymer (P), preferably polyol (P), with the isocyanate component (I) and the reaction with the silane component (S₂)—to be carried out in the reactor of the invention. It is similarly possible to carry out just one process step—preferably the reaction of polymer (P) with the isocyanate component (I)—in the reactor of the invention.

The prepolymers (A) can also be produced by reaction (c) of
polymers (P) with isocyanate-reactive groups selected from groups of formulae —N(R³)H, —OH or —SH, preferably polymers (P) with OH groups, with
silane (S₂) which includes an isocyanate group and conforms to general formula

(R¹)ₐ(R²)₃₋ₐSi—X—B₂ (3),

where B₂ is a radical of formula —N═C═O and R¹, R², X and a are each as defined above.

With all three versions of the method which are mentioned above, the stoichiometries of the reactants are preferably chosen such that the product is isocyanate-free and more than 80%, preferably more than 90% and more preferably more than 95% of all isocyanate-reactive groups have reacted. To obtain an isocyanate-free product, however, the isocyanate-reactive components need not necessarily be used in an equimolar amount or in excess. Since the isocyanate groups undergo by-reactions, for example formation of biurets during the reaction, it is possible to obtain an isocyanate-free product even when using a slight excess of isocyanate.

In another preferred process, the isocyanate-reactive components are used in deficiency, but instead, after conclusion of the reaction steps of the invention, a further isocyanate-reactive compound is added as a so-called deactivator. This can be selected from a multiplicity of compounds. The only prerequisite is that the functional groups of the compound are able to react with the excess isocyanate groups in a simple reaction. Typical deactivators are alcohols such as, for example, methanol, ethanol, isopropanol, butanol or higher alcohols, and also amines such as, for example, methylamine, ethylamine, butylamine or dibutylamine.

The polyol components (P) mentioned in the abovementioned processes can in principle contain any hydroxyl-containing polymers, oligomers and/or monomers, in which case mixtures of various types of polymer, oligomer and/or monomer can also be used, as will be appreciated. Preferably, the polyol component contains polysiloxanes, polysiloxane-urea/urethane copolymers, polyurethanes, polyureas, polyethers, polyesters, poly(meth)acrylates, polycarbonates, polystyrenes, polyamides, polyvinyl esters or polyolefins such as, for example, polyethylenes, polybutadienes, ethylene-olefin copolymers or styrene-butadiene copolymers.

It is particularly preferable, however, for the polymer component (P) to contain aromatic polyester polyols, aliphatic polyester polyols and/or polyether polyols as extensively described in the literature. It is also particularly preferable to use poly- or oligo-halogenated polyether or polyester polyols such as, for example, IXOL M 125® (brominated polyol from Solvay). The polyol component (P) here can contain not only molecules with 1, 2 or else more hydroxyl groups. The average functionality of the polyol component is preferably between 1 and 5, i.e., it preferably contains from 1 to 5 hydroxyl groups, more preferably on average from 1.5 to 3.5 and more particularly from 1.7 to 2.5 hydroxyl groups.

The average molecular mass Mₙ (number average) of all molecules present in the polyol component (P) is preferably at most 2000, more preferably at most 1100 and more particularly at most 600.

The isocyanate component (I) mentioned in the abovementioned processes can in principle contain any mono-, di- or oligo-functional isocyanates. Preferably, however, it contains in particular di- or more highly functional isocyanates. Examples of customary diisocyanates are diisocyanatodiphenylmethane (MDI) not only in the form of crude or technical grade MDI but also in the form of pure 4,4′ and/or 2,4′ isomers or mixtures thereof, tolylene diisocyanate (TDI) in the form of its various regioisomers, diisocyanato-naphthalene (NDI), isophorone diisocyanate (IPDI) or else in the form of hexamethylene diisocyanate (HDI). Examples of polyisocyanates are polymeric MDI (P-MDI), triphenylmethane triisocyanate or biuret or isocyanurate trimers of the above-mentioned diisocyanates.

Examples of silanes (S₁) with isocyanate-reactive groups of formula (2) are N-phenylaminomethylmethyl-di(m)ethoxysilane, N-phenylaminomethyltri(m)ethoxysilane, N-cyclohexylaminomethylmethyldi(m)ethoxysilane, N-cyclohexylaminomethyltri(m)ethoxysilane, N-alkyl-aminomethylmethyldi(m)ethoxysilane, N-alkylaminomethyl-tri(m)ethoxysilane, where alkyl can be for example methyl, ethyl, n-propyl, isopropyl, n-butyl, isobutyl, t-butyl, the various regioisomers of pentyl, of hexyl, of heptyl and also of even longer-chain alkanes, and also N-phenylaminopropylmethyldi(m)ethoxysilane, N-phenylaminopropyltri(m)ethoxysilane, N-cyclohexyl-aminopropylmethyldi(m)ethoxysilane, N-cyclohexylamino-propyltri(m)ethoxysilane, N-alkylaminopropyl-methyldi(m)ethoxysilane, N-alkylaminopropyl-tri(m)ethoxysilane, where alkyl can be for example methyl, ethyl, n-propyl, isopropyl, n-butyl, isobutyl, t-butyl, the various regioisomers of pentyl, of hexyl, of heptyl and also of even longer-chain alkanes.

Examples of silanes (S₂) with isocyanate groups of formula (3) are isocyanatomethyldimethyl(m)ethoxysilane, isocyanatopropyldimethyl(m)ethoxysilane, isocyanatomethylmethyldi(m)ethoxysilane, isocyanato-propylmethyldi(m)ethoxysilane, isocyanatomethyl-tri(m)ethoxysilane and isocyanatopropyl-tri(m)ethoxysilane.

It may be sensible or necessary to additionally add a catalyst to the reaction mixture. This catalyst can be added in solid form, in liquid form or dissolved in a solvent. The catalysts used depend on the type of reaction. Typically they are acidic or basic compounds or catalysts used for polyurethane synthesis, for example dibutyltin dilaurate, dioctyltin dilaurate, dibutyltin diacetylacetonate, dibutyltin diacetate or dibutyltin dioctoate, etc., also titanates, e.g., titanium(IV) isopropoxide, iron(III) compounds, e.g., iron(III) acetylacetonate, zinc compounds such as zinc acetylacetonate, zinc 2-ethylhexanoate, zinc neodecanoate, or bismuth compounds bismuth (2-ethylhexanoate), bismuth neodecanoate, bismuth tetramethylheptanedionate and also bismuth/tin catalysts such as the Borchi® catalyst. Organic acids such as acetic acid, phthalic acid, benzoic acid, acyl chlorides such as benzoyl chloride, phosphoric acid and its half-esters such as butyl phosphate, dibutyl phosphate, propyl phosphate, etc., phosphonic acids and also their half-esters or else inorganic acids are also suitable. Suitable basic catalysts are for example amines such as, for example, triethylamine, tributylamine, 1,4-diazabicyclo[2,2,2]octane, 1,8-diazabicyclo[5.4.0]undec-7-ene, 1,5-diazabicyclo-[4.3.0]non-5-ene, N,N-bis(N,N-dimethyl-2-aminoethyl)-methylamine, N,N-dimethylcyclohexylamine, N,N-dimethyl-phenylamine, N-ethylmorpholinine, etc.

The catalyst quantities to be added depend on the catalyst system used and range from 10 weight ppm to 1% by weight, preferably from 10 weight ppm to 0.1% by weight and more preferably from 10 weight ppm to 200 weight ppm.

Further auxiliary substances for use in polymer production include additives to set the rheology. A wide variety of solvents or plasticizers are conceivable here, provided they are unable to influence the reaction or co-react themselves. Additives are also conceivable to stabilize the final end product in some way. Typical substances here are photoprotectants, antioxidants, flame retardants, fungicides but also water scavengers and reactive diluents in the case of using reactive silane monomers. It is again a prerequisite here that these substances should not adversely affect either the catalysis or the synthesis of the polymer. The auxiliary substances can be added at different stages of the process.

The viscosity of the prepolymers (A) of the invention is preferably at least 5 Pa·s at 50° C. and more preferably at least 10 Pa·s at 50° C. The viscosity of the prepolymers (A) of the invention is preferably at most 100 Pa·s at 50° C. and more preferably at most 25 Pa·s at 50° C.

At room temperature (25° C.), the viscosities are preferably at least 50 Pa·s, more preferably at least 100 Pa·s and more particularly at least 500 Pa·s. At room temperature (25° C.), the viscosities are preferably at most 1500 Pa·s and more preferably at most 1000 Pa·s.

These high viscosities are particularly necessary in the event of a use of prepolymers (A) for production of sprayable assembly foams in order that, after the foaming of the polymer mixture, stiff foams may be obtained.

The starting materials can be continuously dosed in the required mixing ratio via pumps, pressure lines or suction lines. The starting materials can here be not only fully dosed into the reactor or distributed over the reactor geometry via suitable dosing concepts. The quantities involved can be captured via mass flow measurements, volume flow measurements or balances. The starting materials at this stage can have temperatures of −20° C. to 200° C. The silanes (S₁) and (S₂) are preferably used in a temperature range of −20 to 120° C. and more preferably at 20 to 80° C. The polyol component (P) is preferably used in a temperature range of −20 to 120° C. and more preferably in a temperature range of 20 to 80° C. The isocyanate component (I) is preferably used in a temperature range of 20 to 120° C. and more preferably in a temperature range of 20 to 80° C. The heating involved can be effected for example in the stock reservoir vessel or through a heated dosing line (hot water, steam heating, electric heating, etc.).

When pressure lines and pumps are used, the particular mass flow can be controlled with pumps, the line pressure or a control valve. The dosage quantities can be used to adjust the delay time while heeding the desired stoichiometry.

The method of the invention is characterized in that at least one reaction step is carried out in a reactor (R) which is in accordance with the invention. It is preferably the reaction between the polyol component (P) and the isocyanate component (I) which is carried out in the reactor (R) of the invention. It is preferably the first reaction step which is concerned. Preferably, the polyol component (P) contains molecules having an average molar mass Mₙ (number average) of at most 2000, preferably at most 1100 and more preferably at most 600. This reaction preferably has such a high exotherm that the reaction mixture would heat up by more than 100° C. and usually by more than 150° C. if the reaction is carried out under adiabatic conditions. When the reaction is carried out under the conditions of the invention, the actual temperature increase of the reaction mixture is preferably less than 10° C. and more preferably less than 5° C.

The subsequent step, the reaction with the silane (S₁) or (S₂) of the intermediate product obtained in the first step, can likewise be carried out in a reactor (R) which is in accordance with the invention.

The starting materials are dosed continuously into the reactor (R).

For better reaction and temperature control, the dosing of the starting materials can be distributed over the entire reactor geometry. Distributing the reactant dosing can be for one or more reactants.

After entry into the reactor (R), the starting materials shall be commixed, preferably intensively, with the other starting materials or the reactor contents. The mixing time shall be below the residence time in the reactor. The commixing can here be via static mixers or dynamic mixing assemblies as described in Ullmann's Encyclopedia of Industrial Chemistry (UEIC 2008/A-Z/M/Mixing of Highly Viscous Media—DOI: 10.1002/14356007.b02_{—}26; UEIC 2008/A-Z/C/Continuous Mixing of Fluids DOI: 10.1002/14356007.b04_{—}561).

The temperature in the mixing device and also the subsequent delay time sector is preferably in the range from 20 to 120° C., more preferably in the range from 40 to 110° C. and even more preferably in the range from 70 to 100° C. The desired temperature window can be maintained by selecting the reactant temperatures, the dosing concept for the reactants or by heat removal.

The method of the invention is preferably, carried out at the pressure of the ambient atmosphere, but can also be carried out at higher or lower pressures.

The mixing devices in the continuous reaction apparatus are each followed by delay time sectors for completing the reaction. In addition to an adequate residence time care must be taken to ensure a narrow delay time distribution and minimal backmixing. The downstream delay time sector can be utilized for further commixing. In this case, it is again possible to use static or dynamic mixing assemblies.

The pronounced exothermic nature of the reaction makes it necessary to ensure adequate temperature control. Heat transfer here preferably takes place continuously via heat transfer elements implemented in the reactor (R). Alternatively, such heat transfer elements can also be integrated sequentially in the reaction apparatus for temperature control.

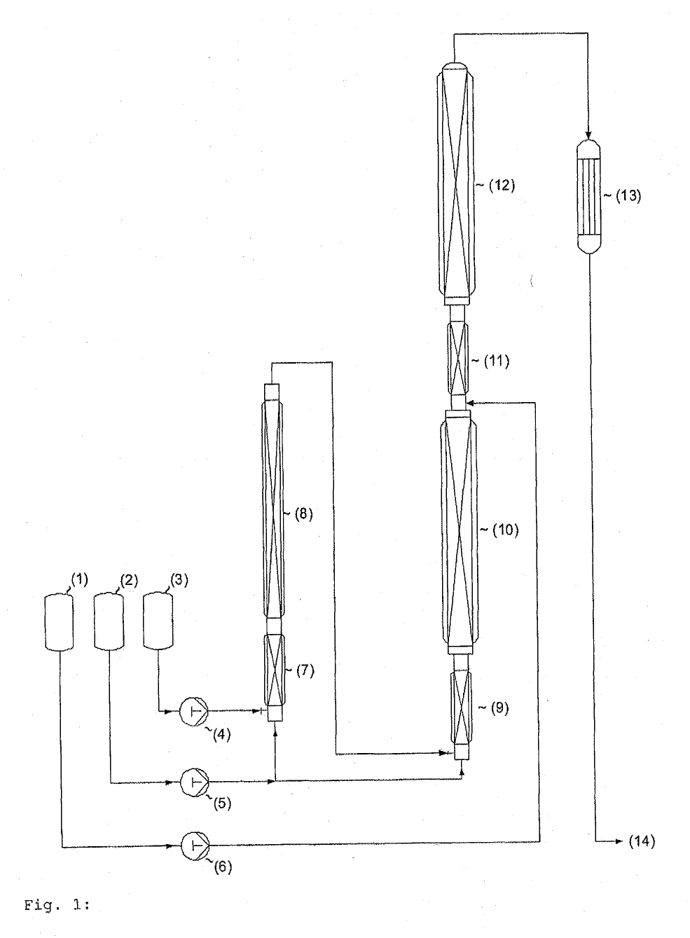

The reaction apparatus must ensure adequate commixing of the reactants, adequate residence time and adequate temperature control. Particular preference is given to a design that combines these process steps, as is the case with static mixers having internal cooling elements. This embodiment is described in FIG. 1.

FIG. 1 shows the preferred process design with parallel mixing sector, temperature management and reaction management. The polyol component is fed from the feed vessel (2) via dosing pump (5) together with the isocyanate component from feed vessel (3) into the mixing sector (7). A sub-stream of polyol component introduced into the 2nd mixing sector (9) can be used to provide even closer control of the temperature in the delay time sectors with heat transfer (8) and (10). To produce the silane-terminated prepolymer, the silane component is subsequently dosed with pump (6) from feed vessel (1) into the mixing sector (11). The product (14) exits the continuous reaction apparatus following the delay time and heat removal sector (12) and also the discharge cooler (13).

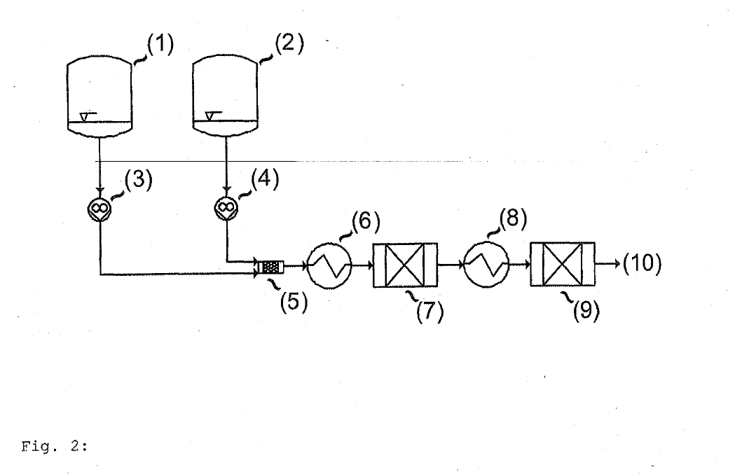

An alternative—albeit unpreferred—embodiment of the continuous process is depicted in FIG. 2 to illustrate the reaction principle using the reaction of polyol component (P) and isocyanate component (I) as an example.

In this embodiment, the delay time sector and the heat removal alternate. The isocyanate component is pumped from the feed vessel (1) via a pump (3) into the mixing sector (5). There the isocyanate component comes into contact with the polyol component which is dosed from the polyol feed vessel (2) via the pump (4) into the mixing sector (5). The mixing sector is followed by the temperature control via the sequential arrangement of heat exchangers (6)+(8) and also the delay time sectors (7)+(9). Following these alternating delay time sectors and heat exchangers the product (10) exits the plant. The removal of an adiabatic reaction temperature increase of 200° C. for example would, given a targeted maximum temperature increase of 10° C. in the reaction medium, require splitting into 20 segments, the residence time of which would have to be adapted to the reaction rate at the particular point in the progress of the reaction.

Product quality in the practice of the process of the invention is preferably tracked via the continuously in-line monitoring of the quality of the starting materials, of the intermediate products and as far as necessary the reaction products. Different parameters can be investigated/measured here. Suitable methods of measurement are any which are able to detect the raw-material quality and/or the conversion of the reaction within a sufficiently short time. These include, for example, spectroscopic methods, such as NIR spectroscopy, FT-IR spectroscopy, Raman-FT spectroscopy, etc. Preferably, the conversion of the reaction is policed. For example, the residual level of silane monomers of general formula (3) can be measured. It is similarly possible to determine the residual isocyanate content, preferably via IR spectroscopy.

The prepolymers (A) of the invention are preferably used in blends (M) with blowing agents (T) and additives as sprayable assembly foams.

Blends (M) containing prepolymers (A) obtained by the method of the invention and blowing agents (T) likewise form part of the subject matter of the invention.

Suitable blowing agents include in principle any room temperature gaseous compounds liquefiable at pressures of preferably less than 40 bar and more preferably less than 20 bar, e.g., propane, butane, i-butane, propane-butane mixtures, dimethyl ether, 1,1,1,3-tetrafluoro-ethane, 1,1-difluoroethane.

### Example 1

### Production of Silane-Terminated Polyether by Continuous Method as Per FIG. 1

Embodiment variant with sequential dosing of polyol component and also parallel temperature management and delay time sector—FIG. 1.

### Dosage Quantities:

| | | |
|---|---|---|
| a) | Isocyanate component | 27.6 kg/h |
| | Composition: | |
| | toluene diisocyanate | 27.6 kg/h |
| b) | Polyol component | 2.2 kg/h |
| | Composition: | |
| | Pluriol P400 | 31.4 kg/h |
| | (polypropylene glycol with molar mass | |
| | 400 from BASF AG) | |
| | cetyl alcohol | 5.24 kg/h |
| | vinyl trimethoxysilane | 5.44 kg/h |
| | (Genosil ® XL10, from Wacker Chemie AG) | |
| | phosphoric acid | 0.07 kg/h |

The polyol component is split into two equal-sized sub-streams in accordance with FIG. 1.

| | | |
|---|---|---|
| c) | Silane component | 30.3 kg/h |
| | Composition: | |
| | N-phenylaminomethylmethyldimethoxy- | 30.2 kg/h |
| | silane (Geniosil ® XL972, from Wacker | |
| | Chemie AG) | |
| | 2,2′-dimorpholinyl diethyl ether | 0.10 kg/h |
| | (DMDEE) | |

The reactors in FIG. 1 are tubular reactors with static mixers and internal cooling loops, which provide a heat removal performance of above 5 kW/m³·K to ensure adequate removal of heat.

The temperature in the mixing sector is 50° C. and the temperature in the delay time sector is 80° C. The temperature difference between the reaction medium and the cooling medium is at most 10° C. The temperature in the reaction medium rises by at most 5° C. during the reaction.

The polyol component is fed from the feed vessel (2) via dosing pump (5) together with the isocyanate component from feed vessel (3) into the mixing sector (7). A sub-stream of polyol component introduced into a 2nd mixing sector (9) can be used to provide even closer control of the temperature in the delay time sectors with heat transfer (8) and (10). To produce the silane-terminated prepolymer, the silane component is subsequently dosed with pump (6) from feed vessel (1) into the mixing sector (11). The product (14) exits the continuous reaction apparatus following the delay time and heat removal sector (12) and also the discharge cooler (13).

The reaction product has a viscosity of about 13 Pas at 50° C.

Comparison with Prior Art:

The reaction described under Example 1 is not performable in conventional tubular reactors as described in WO 2006/136261 A1 for example. This reaction exhibits an exotherm which can lead to a temperature increase >200° C. under adiabatic reaction management. To achieve adequate cooling here in a tubular reactor, this tubular reactor would have to have not only a large surface to volume ratio, ditto a very small diameter, and this would require an immense pumping power in view of the high product viscosity.

In addition, the cooling medium would have to have such a low temperature that reaction operation at substantially constant temperature would not be possible in practice owing to wall effects. But this narrow temperature management is a prerequisite for a successful course of reaction, since excessively high reaction temperatures cause secondary and degradation reactions, while excessively low temperatures lead to an abrupt increase in viscosity. In addition, the wall effects (low temperatures at the reactor wall, high temperatures in the reactor center) would result in extremely nonuniform residence times in the reactor.

### Example 2

### Production of Foamable Mixture

50 g of prepolymer from Example 1 are introduced into a pressure glass with valve and admixed with 1.2 g of B8443® foam stabilizer (from Goldschmidt) and with 0.3 ml of butyl phosphate as catalyst. This mixture is subsequently with 18 ml of a propane-butane mixture (having a propane/butane ratio of 2:1) and 1 ml of dimethyl ether.

This gives an emulsion which is easy to foam at room temperature through a plastic tube (about 20 cm in length and about 6 mm in diameter) which is threaded onto the valve and through which the foam can be conveniently and accurately applied even into narrow joints. The foam obtained in the process is stiff and, after it has cured, has high hardness, good pore structure and is not brittle.

What is claimed is:

1. A method for continuous production of prepolymers (A) having end groups of general formula (1)
(R¹)ₐ(R²)₃₋ₐSi—X-A- (1),
where the end groups (1) can be the same or different,
A is a divalent linking group selected from —(R³)N—CO—NH—, —HN—CO—N(R³)—, —O—CO—HN—, —HN—CO—O—, —S—CO—HN—, —HN—CO—S—,
X is a divalent linear or branched alkyl group of 1-10 carbon atoms which is optionally substituted with halogen atoms,
R¹ is an optionally halogen-substituted alkyl, cycloalkyl, alkenyl or aryl radical of 1-10 carbon atoms,
R² is an alkoxy radical —OR³, an acetoxy radical —O—CO—R³, an oxime radical —O—N═C(R³)₂ or an amine radical —NHR³ or —NR³₂,
R³ is hydrogen, a linear, cyclic or branched radical of 1 to 18 carbon atoms which is optionally substituted with heteroatoms, preferably an alkyl or alkenyl radical wherein the carbon chain may optionally be interrupted with oxygen atoms, or an optionally substituted aryl radical of 1 to 18 carbon atoms,
R⁴ is a linear, branched or crosslinked polymer radical,
a is 0, 1 or 2, and
n is an integer of at least 1,
by producing the prepolymers (A) by a continuous process comprising at least one reaction of an isocyanate group (—N═C═O) with at least one isocyanate-reactive group conducted continuously in at least one reactor (R) which provides heat removal powers above 5 kW/(m³·K) in the laminar region of flow.

2. The method according to claim 1, characterized in that the reactor includes internal cooling elements and more particularly internal cooling loops for heat removal.

3. The method according to claim 1 or 2, characterized in that the temperature difference between the reaction medium and the cooling medium is at most 20° C. and preferably at most 10° C.

4. The method according to claim 1, 2 or 3, characterized in that the temperature during the reaction in reactor (R) increases by not more than 10° C.

5. The method according to any one of claims 1 to 4, characterized in that the reactors (R) contain mixing devices in which the feeds used are continuously mixed, and downstream delay time sectors in which the reaction is carried out in a continuous manner and heat removal takes place at the same time.

6. The method according to any one of claims 1 to 5, characterized in that the feeds used are mixed at temperatures of 20 to 110° C. before the reaction.

7. The method according to any one of claims 1 to 6, characterized in that the reaction in reactor (R) is carried out at a temperature of 40 to 110° C.

8. The method according to any one of claims 1 to 7, characterized in that the prepolymers (A) are produced by reaction (a)
of polymers (P) with isocyanate-reactive groups selected from groups of formulae —N(R³)H, —OH or —SH, preferably polymers (P) with OH groups, with
an isocyanate component (I) selected from mono-, di- and polyisocyanates and mixtures thereof, and
a silane (S₁) which includes an isocyanate-reactive group and conforms to general formula
(R¹)ₐ(R²)₃₋ₐSi—X—B₁ (2),
where B₁ is an isocyanate-reactive group selected from groups of formulae —N(R³)H, —OH or —SH, and R¹, R², X and a are each as defined in claim 1,
with the proviso that
(i) polymer (P) is reacted first with isocyanate component (I) and then with silane (S₁), or
(ii) isocyanate component (I) is reacted first with silane (S₁) and then with polymer (P), or
(iii) polymer (P), isocyanate component (P) and silane (S₁) are reacted at the same time.

9. The method according to any one of claims 1 to 7, characterized in that the prepolymers (A) are produced by reaction (b)
of polymers (P) with isocyanate-reactive groups selected from groups of formulae —N(R³)H, —OH or —SH, preferably polymers (P) with OH groups, with
an isocyanate component (I) selected from mono-, di- and polyisocyanates and mixtures thereof, and
a silane (S₂) which includes an isocyanate group and conforms to general formula
(R¹)ₐ(R²)₃₋ₐSi—X—B₂ (3),
where B₂ is a radical of formula —N═C═O and R¹, R², X and a are each as defined in claim 1,
with the proviso that
(i) polymer (P) is reacted first with isocyanate component (I) and then with silane (S₂), or
(ii) polymer (P) is reacted first with silane (S₂) and then with isocyanate component (I), or
(iii) polymer (P), isocyanate component (P) and silane (S₁) are reacted at the same time.

10. The method according to any one of claims 1 to 7, characterized in that the prepolymers (A) are produced by reaction (c)
of polymers (P) with isocyanate-reactive groups selected from groups of formulae —N(R³)H, —OH or —SH, preferably polymers (P) with OH groups, with
silane (S₂) which includes an isocyanate group and conforms to general formula
(R¹)ₐ(R²)₃₋ₐSi—X—B₂ (3),
where B₂ is a radical of formula —N═C═O and R¹, R², X and a are each as defined in claim 1.

11. The method according to any one of claims 8 to 10, characterized in that the employed polymer (P) has an average molecular mass Mₙ (number average) of at most 2000.

12. The method according to any one of claims 8 to 11, characterized in that the polymer (P) is reacted with the isocyanate component (I) in a first step in at least one reactor (R) according to any one of claims 1 to 7 in a continuous manner.

13. The method according to any one of claims 8 to 12, characterized in that, in a second step, the intermediate formed from polymer (P) and isocyanate component (I) from the first step is reacted with silane (S₁) or (S₂) in a continuous manner in at least one further reactor (R) according to any one of claims 1 to 7.

14. A blend (M) containing
prepolymers (A) obtained according to any one of claims 1 to 13, and
blowing agent (T).
